(19) United States
(12) Patent Application Publication
(10) Pub. No.: US 2026/0285441 A1
(43) Pub. Date: Sep. 24, 2026

(54) ELECTRICALLY ASSISTED BICYCLE

(71) Applicant: Adrien Richard Bruno LELIEVRE, ORLEANS (FR)

(72) Inventor: Adrien Richard Bruno LELIEVRE, ORLEANS (FR)

(21) Appl. No.: 19/137,148

(22) PCT Filed: Dec. 11, 2023
(86) PCT No.: PCT/EP2023/085186

§ 371 Date: May 11, 2026

(30) Foreign Application Priority Data
Dec. 9, 2022 (FR) FR2213109
Apr. 24, 2023 (FR) FR2304089

(51) Int. Cl. B62M 6/50; B62M 6/60; B62M 6/80

(52) U.S. Cl. CPC B62M 6/50; B62M 6/60; B62M 6/80

(57) ABSTRACT

The invention relates to an electrically assisted pedal cycle, comprising a rear wheel (1), a front wheel, at least one mechanical brake, a crankset (2) mechanically linked to the rear wheel (1), a freewheel-less electric motor (4) supplied with electric current by a module (6) of supercapacitors (9) controlled by a converter (8); the pedal cycle further comprising a device (17) for detecting mechanical braking; an electronic control unit (10) configured to define the operating mode of said electric motor (4), between a first operating mode, called generator mode, in which said motor (4) recharges the module (6) of supercapacitors (9) with electrical energy, and a second operating mode, called propulsion mode, in which the electrical energy stored in the module (6) of supercapacitors (9) powers said motor (4), said unit defining the operation of the electric motor (4) in generator mode as a function of the mechanical braking detected by said device (17), thereby deactivating the propulsion mode and/or triggering motor braking.

The invention relates to an electrically assisted pedal cycle, or EAPC, comprising a rear wheel, a front wheel, at least one mechanical brake, a crankset mechanically linked to the rear wheel, an electric motor used for assistance or for converting kinetic energy into electricity in generator mode, supplied with electrical current from a direct current source by means of a reversible inverter.

EAPCs generally use accumulator batteries as a source of direct current, which batteries, on the one hand, are generally heavy and, on the other hand, require several hours to charge before use and discharge slowly, which is not ideal for intense effort, such as when the EAPC is starting or climbing steep slopes.

It is also known, from document WO 2014/169305, that the electric motor applies its assistance to the crankset, as a function of the speed applied on the EAPC and measured at the pedals.

Document CN 202911902U describes a pedal cycle equipped with an electric motor, but this pedal cycle does not include means for detecting braking. Furthermore, this document does not describe a method allowing a control unit to control an electrical assistance motor that allows switching between two operating modes, namely, a generator mode and a propulsion mode.

One of the aims of the invention is to propose an EAPC without an accumulator battery and without external recharging.

Another aim of the invention is to provide an EAPC capable of regenerating stored energy while being energy self-sufficient.

Another aim of the invention is to improve the comfort of the user when traveling on an EAPC.

Another aim of the invention is to propose an EAPC whose operation when the motor is in generator mode is improved if mechanical braking is detected.

Another aim of the invention is to propose an EAPC whose energy is recharged by the user of the EAPC.

Another aim of the invention is to propose an EAPC whose energy is recharged by the user as a function of their fatigue threshold.

Another aim of the invention is to propose a method for controlling the operation of the motor of an EAPC in assistance or generator mode as a function of the user and/or the environment.

The invention relates to an electrically assisted pedal cycle comprising a rear wheel, a front wheel, at least one mechanical brake, a crankset mechanically linked to the rear wheel, a freewheel-less electric motor supplied with electric current, characterized in that said pedal cycle further comprises:
a module of supercapacitors controlled by a converter and configured to supply said electric motor with electric current or to store said electric current;
means for detecting mechanical braking;
an electronic control unit configured to define the operating mode of said electric motor, between a first operating mode, called generator mode, in which said motor recharges the module of supercapacitors with electrical energy, and a second operating mode, called propulsion mode, in which the electrical energy stored in the module of supercapacitors powers said motor, said unit defining the operation of the electric motor in generator mode as soon as mechanical braking is detected by said detection means, thereby deactivating the propulsion mode and/or triggering motor braking.

According to one embodiment of the invention, the electrically assisted pedal cycle further comprises a pedaling torque sensor and said electronic control unit also defines the operating mode of the electric motor as a function of the pedaling torque.

According to one embodiment of the invention, the electrically assisted pedal cycle further comprises a device for measuring the state of charge of the module of supercapacitors. Preferably, the device for measuring the state of charge is a voltage sensor.

According to one embodiment of the invention, the electrically assisted pedal cycle further comprises at least one pedaling speed sensor linked to the crankset and said electronic control unit also defines the operating mode of the electric motor as a function of the pedaling speed.

According to one embodiment, the electrically assisted pedal cycle further comprises a rotation speed sensor for the electric motor and/or a rotation speed sensor for at least one wheel of said pedal cycle, said electronic control unit also defining the operating mode of the electric motor as a function of the rotation speed of said motor and/or the rotation speed of at least one wheel of said pedal cycle.

According to one embodiment, the electric motor is a freewheel-less reduction motor.

According to one embodiment, the electric motor is a direct drive motor.

According to one embodiment, the electric motor is located in the hub of the rear wheel.

According to one embodiment, the electric motor is located in the hub of the front wheel.

According to one embodiment, the electric motor rotation speed sensor is located in the axle of the wheel supporting the electric motor.

According to one embodiment, the electric motor rotation speed sensor is located on the spokes of one of the wheels.

According to one embodiment, the pedaling torque sensor is integrated into the motor.

According to one embodiment, the pedaling speed sensor is integrated into the motor.

According to one embodiment, the device for detecting mechanical braking is formed by at least one sensor.

According to one embodiment, the device for detecting mechanical braking is formed by at least one contactor.

According to one embodiment, the mechanical link between the crankset and the rear wheel is provided by a chain, a belt or a cardan shaft.

According to one embodiment, the electronic control unit is connected to at least one sensor for detecting the temperature of the module of supercapacitors.

According to one embodiment, the electronic control unit is connected to at least one sensor for detecting the temperature of the electric motor.

According to one embodiment, a voltage sensor measures the state of charge of each of the supercapacitors of the module of supercapacitors.

According to one embodiment, the operation of at least one mechanical brake of the pedal cycle causes a signal to be sent to the electronic control unit, triggering:
the deactivation of the motor assistance;
the application of the motor braking.

According to one embodiment, the electronic control unit continuously monitors, via the sensor for measuring the state of charge of the module of supercapacitors, that the state of charge of the module of supercapacitors always remains less than or equal to 100%.

According to one embodiment, the electronic control unit is configured to determine a gear ratio for said pedal cycle as a function of the pedaling speed and the rotation speed of at least one wheel.

Throughout the text, “electrical assistance” or “controlling the electrical assistance” refers to an operating mode of the electrical assistance motor whereby said motor operates as a propulsion motor using at least some of the electrical energy stored in the module of supercapacitors to propel the pedal cycle forward.

The invention is described hereafter according to one embodiment with reference to the accompanying drawing, in which:

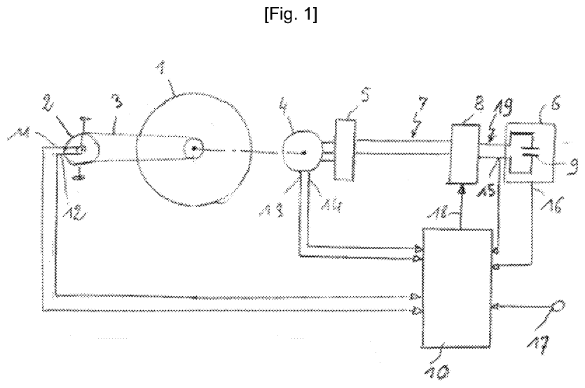

FIG. 1 shows a symbolic schematic diagram of an electrical assistance system for an EAPC according to the invention.

An EAPC equipped with an electrical assistance system according to one embodiment of the invention comprises a frame, a front wheel, a rear wheel 1, two mechanical brakes and a crankset 2 connected to the rear wheel 1, for example, by a chain 3. The electrical assistance system comprises a motor 4, a reversible inverter 5, a converter 8, a module 6 of supercapacitors 9, and an electronic control unit 10 for the converter 8. An electrical connection circuit 7 is disposed between the reversible inverter 5 and the converter 8. An electrical connection circuit 19 is disposed between the converter 8 and the module 6 of supercapacitors 9. A control connection 18 for the converter 8 is disposed between the electronic control unit 10 and the converter 8.

The crankset 2 comprises at least one pedaling torque sensor 11 and at least one pedaling speed sensor 12. The electric motor 4 comprises at least one sensor 13 for detecting the rotation speed of the motor 4 and at least one sensor 14 for detecting the temperature of the motor 4. At least one sensor 15 for detecting the state of charge of the module 6 of supercapacitors 9 is disposed on the connection circuit 19 between the converter 8 and the module 6 of supercapacitors 9. At least one sensor 16 for detecting the temperature of the module 6 of supercapacitors 9 is disposed on the module 6. At least one sensor 17 detects the triggering of mechanical braking by the user of the pedal cycle. The sensors 11-17 are all connected to the electronic control unit 10 of the converter 8.

According to one embodiment of the invention, the electric motor 4 is a freewheel-less reduction motor, placed in the hub of the rear wheel 1. The rotor of the motor 4 is coupled to the rear wheel 1 by means of a speed reducer. By design, a reduction motor is a motor equipped with an internal freewheel and a planetary gear. It is lighter than a conventional motor. The internal freewheel allows zero rolling resistance.

According to one embodiment of the invention, the motor 4 that is used is a reduction motor without an internal freewheel, which ensures that the motor 4, during the braking phases or when running below the fatigue threshold of the user, including when descending, operates in generator mode in order to recharge the energy reserve provided by the module 6 of supercapacitors 9. The converter 8 particularly controls the variation in the direct voltage value between, on the one hand, the reversible inverter 5 and, on the other hand, the module 6 of supercapacitors 9. It also controls the power flows between, on the one hand, the module 6 of supercapacitors 9 and, on the other hand, the motor 4 during periods of electrical assistance to the pedal cycle. Thus, the electric motor 4 is a freewheel-less reduction motor, in order to alternately operate as a propulsion motor for the EAPC in order to assist the user and as an electric current generator in order to recharge the supercapacitors during motor braking phases and during travel phases when the effort is below the fatigue threshold.

The module 6 comprises a plurality of supercapacitors 9, used as cells for storing electrical energy as soon as the pedal cycle is moving or as a source of electrical power during acceleration phases. Unlike a battery, supercapacitors are small components that can be easily mechanically integrated into the pedal cycle. In addition, they are highly safe, allowing them to be directly integrated into the electronic control board. By way of an example, the supercapacitors 9 are housed in extruded tubes that are used as a frame for the luggage rack located above the rear wheel of the EAPC. The energy storage reserve provided by the module 6 of supercapacitors 9 has several advantages over an accumulator battery, and in particular a lower weight, a shorter charging time, a longer service life and lower transfer losses. However, without being detrimental to the advantages of the invention, an accumulator battery can be provided for hybrid operation with the supercapacitors. According to the invention, continuous monitoring via the sensor 15 for detecting the state of charge of the module 6 of supercapacitors 9 ensures that the state of charge of the module of supercapacitors always remains below or equal to 100%.

The operation of the EAPC according to one embodiment of the invention can be as described below.

The user sits on the pedal cycle and drives it using the crankset 2. The pedaling torque sensors 11 and pedaling speed sensors 12 send their signals to the electronic control unit 10 of the converter 8. The sensors 13 for detecting the rotation speed of the motor 4, the sensors 14 for detecting the temperature of the motor 4, the sensors 15 for detecting the state of charge of the module 6 of supercapacitors 9, and the sensors 16 for detecting the temperature of the module 6 of supercapacitors 9 send their signals to the electronic control unit 10 of the converter 8.

During the start-up phase, the user presses the pedal and the pedaling torque sensor notifies the electronic control unit 10 of the need for electrical assistance. The control unit controls the converter 8 so that the electrical energy available in the module 6 of supercapacitors 9 powers the motor 4 by means of the reversible inverter 5. Thus, during the start-up, acceleration or climbing phases, electrical assistance is provided, as in conventional EAPCs, by drawing on the available energy reserve.

The electronic control unit 10 for controlling the operation of the converter 8 receives the electronic signals from the aforementioned sensors and sends control signals to the converter 8 in order to control, as a function of the requirements of the EAPC, and within the limits permitted by the temperatures of the various components, the flow direction of the current in the converter 8, either toward the motor 4 for electrical assistance, or toward the module 6 of supercapacitors 9 for recharging the energy reserve.

The electronic control unit 10 analyzes, on the one hand, the speed of rotation of the electric motor 4 and, on the other hand, the torque applied to the crankset by the user. It uses this information to determine whether the user needs assistance based on the state of charge of the module 6 of supercapacitors, or whether the supercapacitors need to be recharged.

The use of a freewheel-less reduction motor allows the rotation speed of the wheel to be known via the speed of the motor. The electronic control unit 10 analyzes the gear ratio using the rotation speed of the wheel and the pedaling speed in order to better adjust the assistance. If the demand is high but the user is not using the correct gear ratio, this means that before using the assistance, it would be better to change the gear ratio. Thus, for the same level of effort, the assistance is less with a gear ratio that could be improved than when the gear ratio is already the best possible physically.

The torque sensor detects, among other things, the average or instantaneous torque or even the average power of the user in a situation where the user maintains or increases their effort. This is respectively expressed by the willingness of the user to maintain a speed or to increase this speed when the system detects a drop in speed using the motor rotation speed sensor. The electronic control unit thus triggers assistance proportional to the loss of speed recorded in said situation. This allows variations in the terrain to be absorbed by virtue of the assistance of the motor. The user can thus continue pedaling at their own pace without being affected by the variations in the route. This is a speed maintenance function that adapts over time as a function of the stored energy. Indeed, if the consumption continues over time, this means that the user is not in their comfort zone. The speed setpoint to be maintained is therefore gradually reduced in line with the consumption of stored energy until a balance is found between the gear ratio selected by the user and the pedaling torque and/or the pedaling speed. Said setpoint allows the speed of the pedal cycle to be reduced to a non-zero minimum speed in order to maintain the balance of the pedal cycle, as a function of the selected gear ratio.

The pedaling speed sensor allows the electronic control unit to know the gear ratio in order to be able to modulate the difference between the perceived torque and the determined maximum torque and thus trigger acceleration assistance.

When the user wishes to accelerate to increase their cruising speed or to overtake an obstacle on the road, they can also use the assistance of the electrically assisted pedal cycle. However, it is important to ensure that the energy that is drawn and stored is used wisely. The control unit thus allows additional assistance to be activated when the torque applied to the pedals exceeds the maximum torque recorded during the last pedal stroke. The control unit allows additional assistance to be provided based on signals from the pedal torque sensors, this additional assistance stops as soon as the pedaling torque becomes constant or decreases.

The pedal cycle according to one embodiment of the invention allows the stored energy to be used to restart after a stop or even to provide assistance when starting on a hill. When the torque sensor detects pressure on the pedals and the pedal cycle is traveling at less than 6 km/h, the control unit allows electrical assistance to be provided.

In a conventional EAPC, manual operation of one of the brake levers cuts off the power supply of the motor and therefore the assistance provided by the motor. Each of the brake levers is equipped with a contactor or a sensor for cutting off the motor assistance when a brake lever is operated.

Advantageously, and according to the invention, the operation of a first brake lever ensures, by means of the sensor 17, that a signal is sent to the electronic control unit 10, triggering the deactivation of the assistance function of the electric motor, but also the application of the motor braking and the recovery of electrical energy, with the motor operating in generator mode. Operating the first brake lever increases the motor braking and energy recovery. Subsequent or simultaneous operation of the second brake lever significantly increases motor braking and energy recovery. Thus, and according to the invention, operating a first brake lever allows a first signal to be sent from the sensor 17 to the electronic control unit 10 to ensure that the motor operates in generator mode. In addition, the simultaneous or non-simultaneous operation of the second brake lever allows even greater motor braking to be obtained by combining the signals originating from each of the detection means of the brake levers. Furthermore, operating in generator mode therefore can be ensured by applying pressure to at least one brake lever as a function of the state of charge of the module of supercapacitors.

Energy recovery, within the meaning of the invention, is understood to mean the conversion of mechanical energy from pedaling into electrical energy when certain conditions are met, such as a lower effort or low pedaling torque, for example, or even means the conversion of all or some of the kinetic energy into electrical energy during freewheeling or braking phases.

Mechanical braking is achieved by pressing the brake levers beyond the trigger point of the sensor 17 in order to cut off the assistance of the motor. Mechanical braking is used in fast or emergency braking situations.

Furthermore, and unlike conventional electrically assisted pedal cycles, where the brake sensor ensures that the motor stops, the pedal cycle according to the invention allows braking to begin with motor braking. This motor braking then can be supplemented by mechanical braking if necessary using the same brake lever.

Activating a brake adds additional current to the current drawn for energy recovery if the system is in energy recovery modulation mode. Thus, when the brake is activated during an assistance period, with the current recovered at this instant being zero, only the additional current will be drawn during motor braking. This allows the same feeling of deceleration to be maintained irrespective of the situation of the cyclist when the brake was activated.

The use of a freewheel-less reduction motor, or a direct drive motor, and of a module of supercapacitors accepting high power in a short time, allows the motor to be used in generator mode in order to benefit from significant motor braking and energy recovery, as a function of the state of charge of the module 6 of supercapacitors and within the limits allowed by the temperatures of the various components.

During the travel phases without particular limitations, based on data received from the pedaling torque sensor 11 and/or from the pedaling speed sensor 12, the electronic control unit 10 determines a torque limit value CL corresponding to the fatigue threshold of the user.

In addition, it receives, in real-time throughout the pedal strokes, information Cu concerning the torque that is useful for moving the pedal cycle. Comparing the two values shows that, between Cu and CL, there is at least one recharging torque value Cr that is greater than or equal to Cu, and the difference between this and Cu allows the supercapacitors to be recharged without noticeable fatigue on the part of the user.

According to one embodiment of the invention, manual operation of a mechanical brake lever for slight movement ensures, by means of the sensor 17 and the electronic control unit 10, that the pedal cycle operates with the recharging torque Cr of the supercapacitors 9. With torque Cr that is lower than the limit torque CL and is slightly higher than the useful torque Cu for moving the EAPC, a small amount of power is recovered during the relatively long travel period, so as to ensure substantial recharging of the module 6 of supercapacitors 9. Thus, the electronic control unit 10 ensures that the assistance provided by the user for recharging the energy reserve provided by the supercapacitors is managed.

Depending on the measured pedaling torque and/or the pedaling speed provided by the pedaling cadence of the user and/or the rotation speed of the electric motor, the electronic control unit 10 automatically controls the energy storage phases and the assistance to the electric motor 4, independently of the practices of the user for optimizing the management of the electrical energy stored in the module 6 of supercapacitors 9.

In other words, while conventional EAPCs only manage the provision of additional energy, the EAPC according to the invention also manages the energy of the user for recharging the additional energy reserve.

Another aim of the invention relates to a method for controlling an electrically assisted pedal cycle according to all or some of the preceding features, wherein the electronic control unit is configured to define the operating mode of said electrical assistance motor between a first operating mode, called generator mode, in which said motor recharges the module of supercapacitors with electrical energy, and a second operating mode, called propulsion mode, in which the electrical energy stored in the module of supercapacitors powers said motor, said method being characterized in that said generator mode is selected if at least one of the following conditions is met:
detection of the operation of at least one mechanical brake;
Vᵢₙₛₜ≥6 km/h, where Vᵢₙₛₜ corresponds to the instantaneous speed of the pedal cycle;
and in that said propulsion mode is selected if at least one of the following conditions is met and the condition for detecting the operation of at least one mechanical brake in the generator mode is not met:
Cᵢₙₛₜ(Tₙ)≤Cᵢₙₛₜ(Tₙ₊₁) and Vᵢₙₛₜ(Tₙ)≥Vᵢₙₛₜ(Tₙ₊₁), where (Tₙ) corresponds to an instant for determining the instantaneous torque Cᵢₙₛₜ and/or the instantaneous speed Vᵢₙₛₜ of the pedal cycle, (Tₙ₊₁) corresponds to another instant for determining the instantaneous torque Cᵢₙₛₜ and/or the instantaneous speed Vᵢₙₛₜ of the pedal cycle, with (Tₙ₊₁) being later than (Tₙ);
Cᵢₙₛₜ≥Cₘₐₓ, where Cₘₐₓ corresponds to the maximum torque applied by the user to the crankset (2) during a period of time preceding the measurement of Cᵢₙₛₜ;
Cᵢₙₛₜ>0 and Vᵢₙₛₜ≤6 km/h.

The period of time preceding the measurement of Cᵢₙₛₜ at least corresponds to half a pedal revolution.

Thus, and according to the invention, the control unit of the electrically assisted pedal cycle allows energy management to be optimized as a function of the user and of the environment in which the user is traveling when they use the pedal cycle according to the invention.

The condition for detecting the operation of the brake can allow operation in generator mode to be increased and therefore improve energy recovery on the module of supercapacitors. This is a condition that is combined with the condition of the mode applied by default of the generator mode.

According to one variant, the operating mode also can be controlled by the control unit as a function of the state of charge of the module of supercapacitors, notably by virtue of a voltage measurement device, preferably a voltage sensor.

According to this variant, each of the conditions of the generator mode is contingent upon a state of charge I_{module}≤100% and each of the conditions of the propulsion mode is contingent upon a state of charge I_{module}>0%, with I_{module} corresponding to the state of charge of the module of supercapacitors.

Furthermore, controlling the electrical assistance motor in generator mode allows the following to be obtained:
an energy recovery function applied by default that is modulated in real-time in relation to the instantaneous torque applied by the user to the crankset if the condition “Vᵢₙₛₜ≥6 km/h” is met, with this condition also corresponding to a generator mode applied by default by the control unit;
a motor braking function whenever mechanical braking is detected, such as when the user operates at least one brake lever, if the “detection of the operation of at least one mechanical brake” condition is met. The motor braking that is obtained is amplified when both brakes are applied.
   The energy recovery function of the generator mode applied by default is substituted as soon as one of the conditions for operation in propulsion mode is met and/or as soon as mechanical braking is detected.
   Furthermore, the control unit is configured to establish a priority between each of the conditions of the operating modes of the electric motor in generator mode or in propulsion mode.

To this end, the following order of priority is applied by the control unit as a function of the conditions of each operating mode, from the lowest priority to the highest priority:

$$MGen default < MProp < MGen brake$$

where MGen default corresponds to the generator mode of the motor defined by the control unit by default when the condition Vᵢₙₛₜ≥6 km/h is met;
where MProp corresponds to the propulsion mode of the motor defined by the control unit if at least one of the following conditions is met:

$${C}_{inst} ( {T}_{n} ) \leq {C}_{inst} ( {T}_{n + 1} ) and {V}_{inst} ( {T}_{n} ) \geq {V}_{inst} ( {T}_{n + 1} ) ;$$

$${C}_{inst} \geq {C}_{max} ;$$

$${C}_{inst} > 0 and {V}_{av} \leq 6 km / h ;$$

where MGen brake corresponds to the generator mode of the motor defined by the control unit as soon as the mechanical braking detection condition is met, with this condition being a priority condition that prevents and/or interrupts the operation in propulsion mode and which can be combined with the default generator mode Mgen default in order to amplify the recharging of the module of supercapacitors.

Furthermore, controlling the electrical assistance motor in propulsion mode allows the following to be obtained:
an acceleration function to accompany the rapid acceleration demands of the user if the condition “Cᵢₙₛₜ≥Cₘₐₓ” is met;
a speed maintenance function to allow the user to maintain their travel speed when faced with constraints such as wind, false flats or even hills when the condition “Cᵢₙₛₜ(Tₙ)≤Cᵢₙₛₜ(Tₙ₊₁) and Vᵢₙₛₜ(Tₙ)≥Vᵢₙₛₜ(Tₙ₊₁)” is met;
a start-assist function, notably for starting on hills when the condition “Cᵢₙₛₜ>0 and Vᵢₙₛₜ≤6 km/h” is met.

Furthermore, the control unit of the pedal cycle according to the invention is configured to select the energy recovery function as the default operating mode of the electric motor. The mechanical braking detection condition takes priority over the others and deactivates the propulsion mode.

1. An electrically assisted pedal cycle, comprising a rear wheel, a front wheel, at least one mechanical brake, a crankset mechanically linked to the rear wheel, a freewheel-less electric motor supplied with electric current, characterized in that said pedal cycle further comprises:
a module of supercapacitors controlled by a converter and configured to supply said electric motor with electric current or to store said electric current;
a device for detecting mechanical braking;
an electronic control unit configured to define the operating mode of said electric motor, between a first operating mode, called generator mode, in which said motor recharges the module of supercapacitors with electrical energy, and a second operating mode, called propulsion mode, in which the electrical energy stored in the module of supercapacitors powers said motor, said unit defining the operation of the electric motor in generator mode as a function of the mechanical braking detected by said device, thereby deactivating the propulsion mode and/or triggering motor braking.

2. The electrically assisted pedal cycle as claimed in claim 1, characterized in that it further comprises a pedaling torque sensor and in that said electronic control unit also defines the operating mode of said electric motor as a function of the pedaling torque.

3. The electrically assisted pedal cycle as claimed in claim 2, characterized in that it further comprises at least one pedaling speed sensor linked to the crankset and in that said electronic control unit also defines the operating mode of the electric motor as a function of the pedaling speed.

4. The electrically assisted pedal cycle as claimed in claim 2, characterized in that it further comprises a rotation speed sensor for the electric motor and/or a rotation sensor for at least one wheel, said electronic control unit also defining the operating mode of the electric motor as a function of the rotation speed of the motor and/or the rotation of at least one wheel.

5. The assisted pedal cycle as claimed in claim 4, characterized in that said electronic control unit is configured to determine a gear ratio for said pedal cycle as a function of the pedaling speed and the rotation speed of at least one wheel.

6. The electrically assisted pedal cycle as claimed in claim 2, characterized in that the pedaling torque sensor is integrated into the electric motor.

7. The electrically assisted pedal cycle as claimed in claim 1, characterized in that the electric motor is a freewheel-less reduction motor.

8. The electrically assisted pedal cycle as claimed in claim 1, characterized in that the electric motor is a direct drive motor.

9. The electrically assisted pedal cycle as claimed in claim 1, characterized in that the electric motor is located in the hub of the rear wheel.

10. The electrically assisted pedal cycle as claimed in claim 1, characterized in that the electric motor is located in the hub of the front wheel.

11. The electrically assisted pedal cycle as claimed in claim 1, characterized in that the device for detecting mechanical braking is formed by at least one sensor.

12. The electrically assisted pedal cycle as claimed in claim 1, characterized in that the electronic control unit is connected to at least one sensor for detecting the temperature of the module of supercapacitors.

13. The electrically assisted pedal cycle as claimed in claim 1, characterized in that the electronic control unit is connected to at least one sensor for detecting the temperature of the electric motor.

14. The electrically assisted pedal cycle as claimed of claim 1, characterized in that it comprises a voltage sensor for measuring the state of charge of the module of supercapacitors.

15. The electrically assisted pedal cycle as claimed in claim 14, characterized in that the electronic control unit continuously monitors, via the sensor for measuring the state of charge of the module of supercapacitors, that the state of charge of the module of supercapacitors always remains less than or equal to 100%.

16. A method for controlling an electrically assisted pedal cycle comprising a rear wheel, a front wheel, at least one mechanical brake, a crankset mechanically linked to the rear wheel, a freewheel-less electric motor supplied with electric current, a module of supercapacitors controlled by a converter and configured to supply said electric motor with electric current or to store said electric current, a device for detecting mechanical braking, and an electronic control unit, wherein the electronic control unit is configured to define the operating mode of said electrical assistance motor between a first operating mode, called generator mode, in which said motor recharges the module of supercapacitors with electrical energy, and a second operating mode, called propulsion mode, in which the electrical energy stored in the module of supercapacitors powers said motor, said method being characterized in that said generator mode is selected if at least one of the following conditions is met:
detection of the operation of at least one mechanical brake;
Vinst≥6 km/h, where Vinst corresponds to the instantaneous speed of the pedal cycle;
and in that said propulsion mode is selected if at least one of the following conditions is met and the condition for detecting the operation of at least one mechanical brake in the generator mode is not met:
$$Cinst ( Tn ) \leq Cinst ( Tn + 1 ) and Vinst ( Tn ) \geq Vinst ( Tn + 1 ) , where ( Tn )$$
corresponds to an instant for determining the instantaneous torque Cinst and/or the instantaneous speed Vinst of the pedal cycle, (Tn+1) corresponds to another instant for determining the instantaneous torque Cinst and/or the instantaneous speed Vinst of the pedal cycle, with (Tn+1) being later than (Tn);
Cinst≥Cmax, where Cmax corresponds to the maximum torque applied by the user to the crankset (2) during a period of time preceding the measurement of Cinst;
$$Cinst > 0 and Vinst \leq 6 km / h .$$
